(19) United States
(12) Patent Application Publication
(10) Pub. No.: US 2008/0219030 A1
(43) Pub. Date: Sep. 11, 2008

(54) ISOLATED DC/DC AND DC/AC CONVERTERS AND CONTROLLING METHODS THEREOF HAVING RELATIVELY BETTER EFFECTIVENESS

(75) Inventor: Shih-Hsien Chang, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 11/776,628

(22) Filed: Jul. 12, 2007

(30) Foreign Application Priority Data
Mar. 8, 2007 (TW) 96108084

(51) Int. Cl. H02M 3/335; H02M 7/797

(52) U.S. Cl. 363/17; 363/98

(57) ABSTRACT

The configurations of an isolated DC/DC converter and an isolated DC/AC converter and the controlling methods thereof are provided. The proposed isolated DC/DC converter includes a DC/AC switching device, a transformer, a rectifier, and a duty ratio and frequency modulating apparatus coupled to the rectifier and the DC/AC switching device for generating a driving signal to adjust a duty ratio and a frequency of the switching device so as to regulate an output DC voltage of the converter.

### FIELD OF THE INVENTION

The present invention relates to an isolated DC/DC converter and an isolated DC/AC converter. More particularly, the present invention relates to an isolated DC/DC converter having a duty ratio and frequency modulating apparatus and an isolated DC/AC converter having a duty ratio and frequency modulating apparatus.

### BACKGROUND OF THE INVENTION

Please refer to FIG. 1, which shows a schematic circuit diagram of an isolated DC/DC converter having a frequency modulating apparatus in the prior art. The isolated DC/DC converter having a frequency modulating apparatus 1 includes a DC/AC switching device 11, a frequency modulating device 12, a rectifier 13, an input capacitor C_{I}, a block capacitor C_{B}, a leakage inductor Lk, a transformer TR and an output capacitor C_{O}. In which, the DC/AC switching device receives an input DC voltage V_{IN} for outputting a first AC output voltage (not shown) and includes a first power switch module having a first power switch Q1 and a first diode D1, a second power switch module having a second power switch Q2 and a first diode D2, a third power switch module having a third power switch Q3 and a third diode D3 and a fourth power switch module having a fourth power switch Q4 and a fourth diode D4. The frequency modulating apparatus 12 includes a voltage sensor 121, a comparator 122 and a frequency modulator 123. The rectifier 13 includes a first rectifying diode Dr1 and a second rectifying diode Dr2. The frequency modulating apparatus 12 generates an error signal based on a sensed voltage generated by the voltage sensor 121 and a reference voltage via the comparator 122 (see FIG. 1, the error signal is a feedback signal), and the error signal is inputted to a feedback terminal of the frequency modulator 123. The frequency modulator 123 generates a driving signal according to the error signal, and the driving signal is outputted from a gate drive terminal of the frequency modulator 123 and is sent to the respective control terminals of the first to the fourth power switches (Q1-Q4) for modulating the frequency of the DC/AC switching device 11 (the waveform of the frequency is shown as a waveform diagram at the connecting node of C_{B} and Lk in FIG. 1) so as to regulate a DC output voltage V_{O}, which is a voltage in between the output capacitor C_{O} and a ground.

Please refer to FIG. 2, which shows a schematic circuit diagram of an isolated DC/DC converter having a duty ratio modulating apparatus in the prior art. The isolated DC/DC converter having a duty ratio modulating apparatus 2 includes a DC/AC switching device 11, a duty ratio modulating device 21, a rectifier 13, an input capacitor C_{I}, a block capacitor C_{B}, a leakage inductor Lk, a transformer TR and an output capacitor C_{O}. In which, the duty ratio modulating apparatus 21 includes a voltage sensor 121, a comparator 122 and a duty ratio modulator 211. The duty ratio modulating apparatus 21 generates an error signal (see FIG. 2, the error signal is a feedback signal) based on a sensed voltage generated by the voltage sensor 121 and a reference voltage via the comparator 122, and the error signal is inputted to a feedback terminal of the duty ratio modulator 211. The duty ratio modulator 211 generates a driving signal according to the error signal, and the driving signal is outputted from a gate drive terminal of the duty ratio modulator 211, and is sent to the respective control terminals of the first to the fourth power switches (Q1-Q4) for modulating the duty ratio of the DC/AC switching device 11 (the waveform of the duty ratio is shown as a waveform diagram at the connecting node of C_{B} and Lk in FIG. 2) so as to regulate a DC output voltage V_{O}, which is the voltage in between the output capacitor C_{O} and the ground.

Please refer to FIG. 3, which shows a schematic circuit diagram of an isolated DC/AC converter having a frequency modulating apparatus in the prior art. The isolated DC/AC converter having a frequency modulating apparatus 3 includes a DC/AC switching device 11, a frequency modulating device 31, an input capacitor C_{I}, a block capacitor C_{B}, a plurality of transformers (each of which is represented by TR), a leakage inductor Lk, and a plurality of fluorescent lamps (Cb1+Lp1, Cb2+Lp2 . . . Cbn+Lpn), in which Cb1, Cb2 . . . Cbn are a plurality of ballast capacitors, and Lp1, Lp2 . . . Lpn are a plurality of fluorescent lamp tubes. The frequency modulating apparatus 31 includes a current sensor 311, a comparator 122 and a frequency modulator 312. The frequency modulating apparatus 31 generates an error signal based on a sensed current generated by the current sensor 311 and a reference voltage via the comparator 122 (see FIG. 3, the error signal is a feedback signal), and the error signal is inputted to a feedback terminal of the frequency modulator 312. The frequency modulator 312 generates a driving signal according to the error signal, and the driving signal is outputted from a gate drive terminal of the frequency modulator 312 and is sent to the respective control terminals of the first to the fourth power switches (Q1-Q4) for modulating the frequency of the DC/AC switching device 11 (the waveform of the frequency is shown as a waveform diagram at the connecting node of C_{B} and the transformer TR in FIG. 3) so as to regulate an AC output voltage (not shown) across the two connecting nodes of the plurality of the fluorescent lamps electrically connected in parallel (which are equivalent to a load).

Please refer to FIG. 4, which shows a schematic circuit diagram of an isolated DC/AC converter having a duty ratio modulating apparatus in the prior art. The isolated DC/AC converter having a duty ratio modulating apparatus 4 includes a DC/AC switching device 11, a duty ratio modulating apparatus 41, an input capacitor C_{I}, a block capacitor C_{B}, a plurality of transformers (each of which is represented by TR), a leakage inductor Lk, and a plurality of fluorescent lamps (Cb1+Lp1, Cb2+Lp2 . . . Cbn+Lpn), in which Cb1, Cb2 . . . Cbn are a plurality of ballast capacitors, and Lp1, Lp2 . . . Lpn are a plurality of fluorescent lamp tubes. The frequency modulating apparatus 41 includes a current sensor 311, a comparator 122 and a duty ratio modulator 411. The duty ratio modulating apparatus 41 generates an error signal based on a sensed current generated by the current sensor 311 and a reference voltage via the comparator 122 (see FIG. 4, the error signal is a feedback signal), and the error signal is inputted to a feedback terminal of the duty ratio modulator 411. The duty ratio modulator 411 generates a driving signal according to the error signal, and the driving signal is outputted from a gate drive terminal of the duty ratio modulator 411 to the respective control terminals of the first to the fourth power switches (Q1-Q4) for modulating the duty ratio of the DC/AC switching device 11 (the waveform of the duty ratio is shown as a waveform diagram at the connecting node of C_{B} and the transformer TR in FIG. 4) so as to regulate an AC output voltage (not shown) across two connecting nodes of the plurality of the fluorescent lamps electrically connected in parallel (which are equivalent to a load).

Please refer to FIG. 5, which shows a waveform diagram of input voltage (from 300 V to 400 V) vs. frequency (from 55 K to 65 K) while the frequency is modulated to achieve the voltage regulation for a conventional isolated converter and the duty ratio is fixed at 90%. One with an ordinary skill in the field would know that the drawbacks of achieving the voltage regulation via modulating the frequency are that the variation range of the switching frequencies are relatively larger, and certain frequencies of which interfere with other electrical equipments. For example, certain channels of the TV sets are interfered by certain frequencies of which. In order to avoid such an interference phenomenon, the design works for the electronic elements of the aforementioned DC/DC and DC/AC isolated converters are even harder.

Please refer to FIG. 6, which shows a waveform diagram of input voltage (from 300 V to 400 V) vs. duty ratio (from 67.5% to 90%) while the duty ratio is modulated to achieve the voltage regulation for a conventional isolated converter and the frequency is fixed at 55 K. One with an ordinary skill in the field would know that the drawbacks of achieving the voltage regulation via modulating the duty ratio are that the switching noises of the above-mentioned isolated DC/DC and DC/AC converters are relatively larger while they are operating under a relatively high voltage.

Keeping the drawbacks of the prior arts in mind, and employing experiments and research full-heartily and persistently, the applicant finally conceived the isolated DC/DC and DC/AC converters and the controlling methods thereof having a relatively better effectiveness.

### SUMMARY OF THE INVENTION

It is therefore an object of the present invention to provide an isolated DC/DC converter having a relatively better effectiveness to regulate a DC output voltage via adjusting a duty ratio and a frequency of the converter so as to achieve the advantages of having a relatively broader input voltage range and decreasing variation amounts of the duty ratio and the frequency.

It is therefore another object of the present invention to provide an isolated DC/AC converter having a relatively better effectiveness to regulate an AC output voltage via adjusting a duty ratio and a frequency of the converter so as to achieve the advantages of having a relatively broader input voltage range and decreasing variation amounts of the duty ratio and the frequency.

According to the first aspect of the present invention, the isolated DC/DC converter includes a DC/AC switching device receiving a DC input voltage for outputting a first AC output voltage, a transformer receiving the first AC output voltage for outputting a second AC output voltage, a rectifier receiving the second AC output voltage for outputting a DC output voltage and a duty ratio and frequency modulating apparatus coupled to the rectifier and the DC/AC switching device for generating a driving signal to adjust a duty ratio and a frequency of the DC/AC switching device so as to regulate the DC output voltage accordingly.

Preferably, the duty ratio and frequency modulating apparatus includes a voltage sensor coupled to the rectifier for generating a sensed voltage, a comparator receiving the sensed voltage and a reference voltage for generating a feedback signal and a duty ratio and frequency modulator receiving the feedback signal for generating the driving signal to modulate the duty ratio and the frequency accordingly.

Preferably, the feedback signal is a voltage signal.

Preferably, the duty ratio and frequency modulating apparatus is switched between one of a first operational mode and a second operational mode according to the feedback signal, wherein the first operational mode is used to control the frequency, the second operational mode is used to control the duty ratio, the feedback signal is used to modulate the frequency within a first phase range when the duty ratio and frequency modulating apparatus is working under the first operational mode, and the feedback signal is used to modulate the duty ratio within a second phase range when the duty ratio and frequency modulating apparatus is working under the second operational model.

Preferably, the DC/AC switching device has a first input terminal, a second input terminal, a first output terminal and a second output terminal, and further includes a first power switch module including a first power switch having a first terminal coupled to the first input terminal, a second terminal coupled to the second output terminal and a control terminal, and a first diode having an anode coupled to the second terminal of the first power switch and a cathode coupled to the first terminal of the first power switch, a second power switch module including a second power switch having a first terminal coupled to the first output terminal, a second terminal coupled to the second input terminal and a control terminal, and a second diode having an anode coupled to the second terminal of the second power switch and a cathode coupled to the first terminal of the second power switch, a third power switch module including a third power switch having a first terminal coupled to the first terminal of the first power switch, a second terminal coupled to the first output terminal and a control terminal, and a third diode having an anode coupled to the second terminal of the third power switch and a cathode coupled to the first terminal of the third power switch, and a fourth power switch module including a fourth power switch having a first terminal coupled to the second terminal of the first power switch, a second terminal coupled to the second terminal of the second power switch and a control terminal, and a fourth diode having an anode coupled to the second terminal of the fourth power switch and a cathode coupled to the first terminal of the fourth power switch, in which the respective control terminals of the first to the fourth power switches are coupled to the duty ratio and frequency modulating apparatus and receive the driving signal.

Preferably, the isolated DC/DC converter further includes a block capacitor having a first terminal coupled to the first output terminal of the DC/AC switching device and a second terminal, a leakage inductor having a first terminal and a second terminal coupled to the rectifier and an output capacitor having a first terminal coupled to the rectifier and a second terminal coupled to a ground, in which the transformer further includes a primary winding coupled to the second terminal of the block capacitor and the second output terminal of the DC/AC switching device, and a secondary winding having a first terminal coupled to the first terminal of the leakage inductor, a second terminal coupled to the rectifier and a central tap coupled to the second terminal of the output capacitor.

Preferably, the isolated DC/DC converter further includes a block capacitor having a first terminal coupled to the first output terminal of the DC/AC switching device and a second terminal, a leakage inductor having a first terminal coupled to the second terminal of the block capacitor and a second terminal, and an output capacitor having a first terminal coupled to the rectifier and a second terminal coupled to a ground, in which the transformer further includes a primary winding coupled to the second terminal of the leakage inductor and the second output terminal of the DC/AC switching device and a secondary winding having a first and a second terminals coupled to the rectifier and a central tap coupled to the second terminal of the output capacitor.

Preferably, the rectifier is a half-bridge rectifier.

According to the second aspect of the present invention, the isolated DC/AC converter includes a DC/AC switching device receiving a DC input voltage for outputting an AC output voltage and a duty ratio and frequency modulating apparatus coupled to the DC/AC switching device for generating a driving signal to adjust a duty ratio and a frequency of the DC/AC switching device so as to regulate the AC output voltage accordingly.

Preferably, the isolated DC/AC converter further includes a transformer having a secondary winding, in which the duty ratio and frequency modulating apparatus includes a current sensor coupled to the secondary winding for generating a sensed current, a comparator receiving the sensed current and a reference voltage for generating a feedback signal and a duty ratio and frequency modulator receiving the feedback signal for generating the driving signal to modulate the duty ratio and the frequency accordingly.

Preferably, the feedback signal is a current signal.

Preferably, the isolated DC/AC converter further includes a block capacitor having a first terminal coupled to the first output terminal of the DC/AC switching device and a second terminal, a leakage inductor having a first terminal and a second terminal, a load having a first terminal coupled to the second terminal of the leakage inductor and a second terminal coupled to the duty ratio and frequency modulating apparatus and a transformer having a primary winding coupled to the second terminal of the block capacitor and the second output terminal of the DC/AC switching device, and a secondary winding coupled to the first terminal of the leakage inductor and the duty ratio and frequency modulating apparatus.

Preferably, the isolated DC/AC converter further includes a block capacitor having a first terminal coupled to the first output terminal of the DC/AC switching device and a second terminal, a leakage inductor having a first terminal coupled to the second terminal of the block capacitor and a second terminal, a load having a first terminal and a second terminal coupled to the duty ratio and frequency modulating apparatus and a transformer having a primary winding having a first terminal coupled to the second terminal of the leakage inductor and a second terminal coupled to the second output terminal of the DC/AC switching device, and a secondary winding having a first terminal coupled to the first terminal of the load and a second terminal coupled to the duty ratio and frequency modulating apparatus.

According to the third aspect of the present invention, the controlling method for an isolated DC/DC converter, in which the converter includes a DC/AC switching device, a rectifier and a duty ratio and frequency modulating apparatus coupled to the rectifier and the DC/AC switching device, includes the steps of: (a) receiving a DC input voltage via the DC/AC switching device for outputting an AC output voltage; (b) receiving the AC output voltage via the rectifier for outputting a DC output voltage; and (c) generating a driving signal via the duty ratio and frequency modulating apparatus for adjusting a duty ratio and a frequency of the DC/AC switching device so as to regulate the DC output voltage accordingly.

Preferably, the step (c) further comprises the steps of: (c1) generating a feedback signal via the duty ratio and frequency modulating apparatus such that the duty ratio and frequency modulating apparatus is switched between a first operational mode and a second operational mode accordingly; (c2) controlling the frequency through the first operational mode and controlling the duty ratio through the second operational mode; (c3) modulating the frequency within a first phase range based on the feedback signal so as to generate the driving signal when the duty ratio and frequency modulating apparatus is working under the first operational mode; and (c4) modulating the duty ratio within a second phase range based on the feedback signal so as to generate the driving signal when the duty ratio and frequency modulating apparatus is working under the second operational mode.

Preferably, the duty ratio and frequency modulating apparatus includes a voltage sensor coupled to the rectifier for generating a sensed voltage, in order to output the feedback signal accordingly.

According to the fourth aspect of the present invention, the controlling method for an isolated DC/AC converter, in which the converter includes a DC/AC switching device and a duty ratio and frequency modulating apparatus coupled to the DC/AC switching device, includes the steps of: (a) receiving a DC input voltage via the DC/AC switching device for outputting an AC output voltage; and (b) generating a driving signal via the duty ratio and frequency modulating apparatus for adjusting a duty ratio and a frequency of the switching device so as to regulate the AC output voltage accordingly.

Preferably, the step (b) further comprises the steps of: (b1) generating a feedback signal via the duty ratio and frequency modulating apparatus such that the duty ratio and frequency modulating apparatus is switched between a first operational mode and a second operational mode accordingly; (b2) controlling the frequency through the first operational mode and controlling the duty ratio through the second operational mode; (b3) modulating the frequency within a first phase range based on the feedback signal so as to generate the driving signal when the duty ratio and frequency modulating apparatus is working under the first operational mode; and (b4) modulating the duty ratio within a second phase range based on the feedback signal so as to generate the driving signal when the duty ratio and frequency modulating apparatus is working under the second operational mode.

Preferably, the isolated DC/AC converter further includes a transformer having a secondary winding, and the duty ratio and frequency modulating apparatus includes a current sensor coupled to the second winding for generating a sensed current, in order to output the feedback signal accordingly.

The present invention may best be understood through the following descriptions with reference to the accompanying drawings, in which:

### BRIEF DESCRIPTION OF THE DRAWINGS

FIG. 1 shows a schematic circuit diagram of an isolated DC/DC converter having a frequency modulating apparatus in the prior art;

FIG. 2 shows a schematic circuit diagram of an isolated DC/DC converter having a duty ratio modulating apparatus in the prior art;

FIG. 3 shows a schematic circuit diagram of an isolated DC/AC converter having a frequency modulating apparatus in the prior art;

FIG. 4 shows a schematic circuit diagram of an isolated DC/AC converter having a duty ratio modulating apparatus in the prior art;

FIG. 5 shows a waveform diagram of input voltage vs. frequency while the frequency is modulated to achieve the voltage regulation for a conventional isolated converter and the duty ratio is 90%;

FIG. 6 shows a waveform diagram of input voltage vs. frequency while the duty ratio is modulated to achieve the voltage regulation for a conventional isolated converter and the frequency is 55 K;

FIG. 7 shows a schematic circuit diagram of an isolated DC/DC converter having a duty ratio and frequency modulating apparatus according to the first preferred embodiment of the present invention;

FIG. 8 shows a schematic circuit diagram of an isolated DC/AC converter having a duty ratio and frequency modulating apparatus according to the second preferred embodiment of the present invention;

FIG. 9 shows a waveform diagram of input voltage vs. frequency and duty ratio while the duty ratio and the frequency of the provided converter according to the first/the second preferred embodiments of the present invention are modulated to achieve a relatively broader input voltage range;

FIG. 10 shows a waveform diagram of input voltage vs. frequency and duty ratio while the duty ratio and the frequency of the provided converter according to the first/the second preferred embodiments of the present invention are modulated to achieve relatively lower changing amounts of duty ratio and frequency;

FIG. 11(a) shows a waveform diagram of feedback voltage vs. frequency/duty ratio, which indicates a decrease of the feedback voltage while changing the frequency within a first phase range when the duty ratio and frequency modulating apparatus of the first/the second preferred embodiments of the present invention is working under a first operational mode, and changing the duty ratio within a second phase range when the duty ratio and frequency modulating apparatus is working under a second operational mode respectively; and

FIG. 11(b) shows a waveform diagram of feedback voltage vs. frequency/duty ratio, which indicates an increase of the feedback voltage while changing the frequency within a first phase range when the duty ratio and frequency modulating apparatus of the first/the second preferred embodiments of the present invention is working under a first operational mode, and changing the duty ratio within a second phase range when the duty ratio and frequency modulating apparatus is working under a second operational mode respectively.

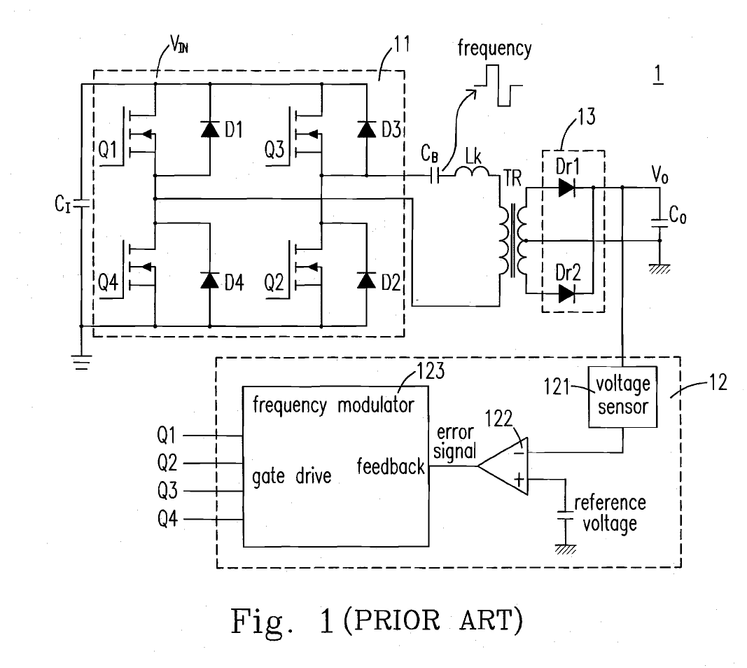

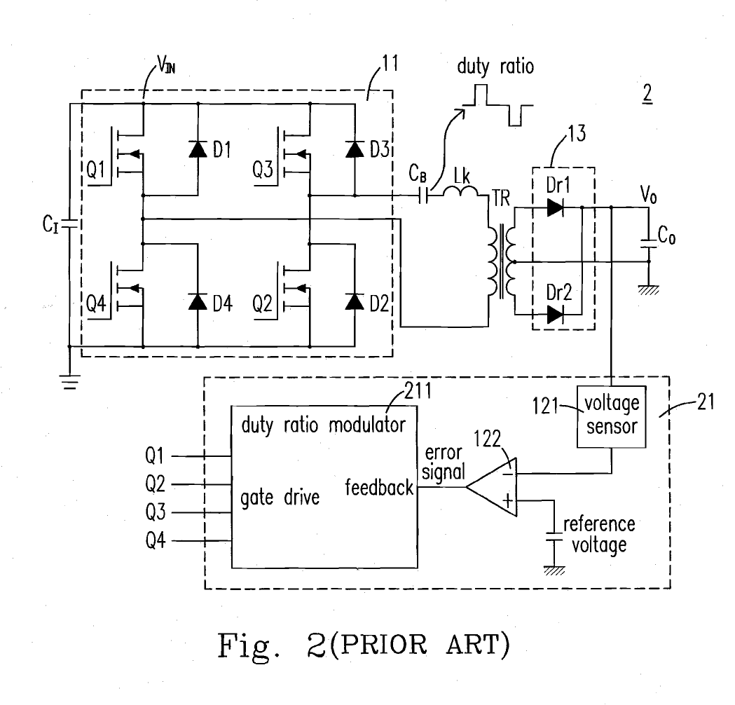

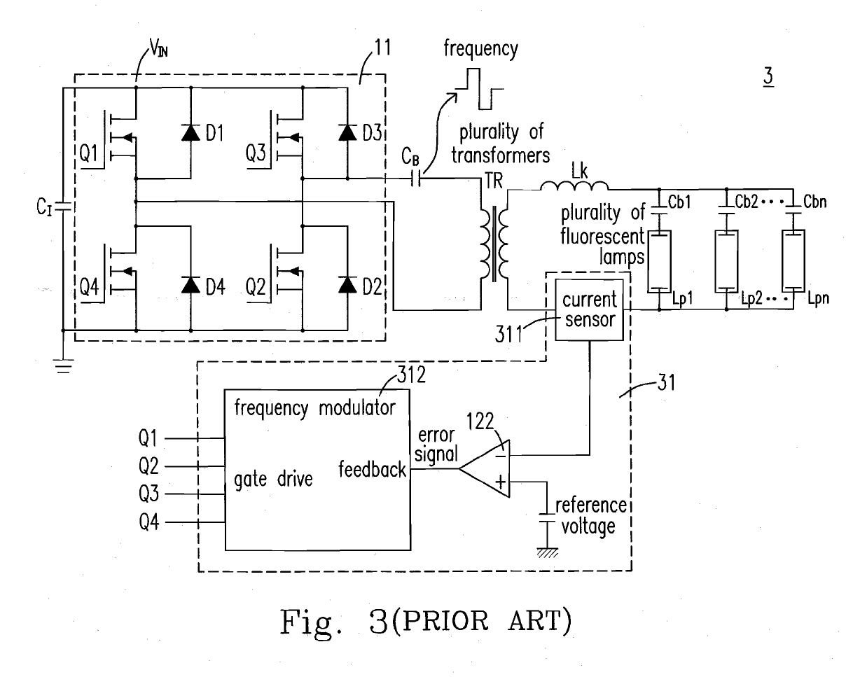

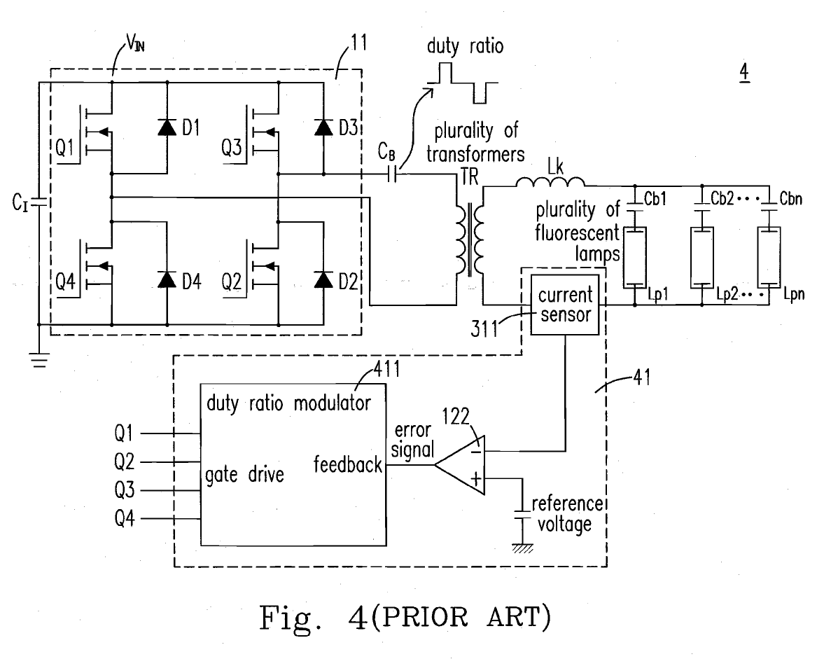

### DETAILED DESCRIPTION OF THE PREFERRED EMBODIMENT

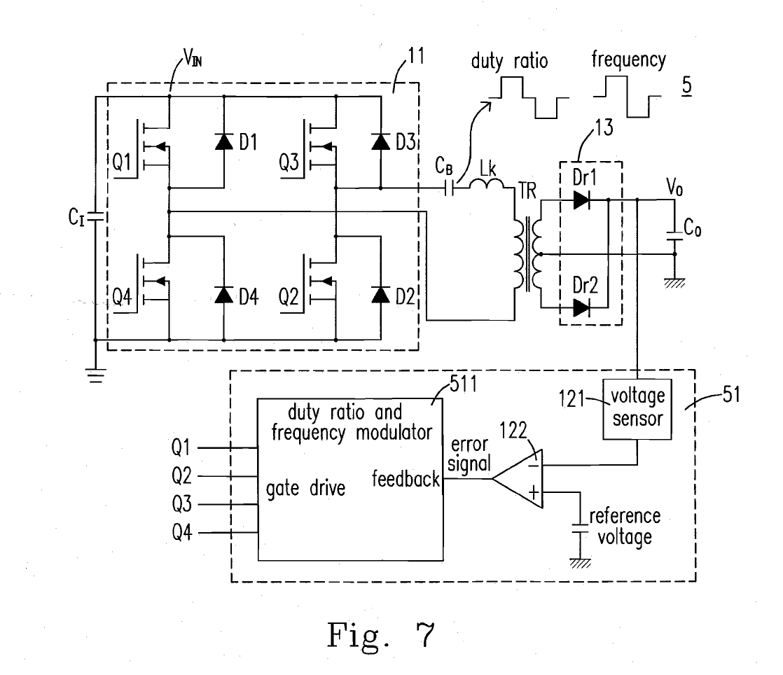

Please refer to FIG. 7, which shows a schematic circuit diagram of an isolated DC/DC converter having a duty ratio and frequency modulating apparatus according to the first preferred embodiment of the present invention. The isolated DC/DC converter having a duty ratio and frequency modulating apparatus 5 includes a DC/AC switching device 11, a duty ratio and frequency modulating apparatus 51, a leakage inductor Lk, a transformer TR, a rectifier 13, an input capacitor C_{I}, a block capacitor C_{B} and an output capacitor C_{O}. In which, the DC/AC switching device 11 receives an input DC voltage V_{IN} for outputting a first AC output voltage (not shown) and includes a first power switch module having a first power switch Q1 and a first diode D1, a second power switch module having a second power switch Q2 and a first diode D2, a third power switch module having a third power switch Q3 and a third diode D3 and a fourth power switch module having a fourth power switch Q4 and a fourth diode D4. The duty ratio and frequency modulating apparatus 51 includes a voltage sensor 121, a comparator 122 and a duty ratio and frequency modulator 511. The rectifier 13 includes a first rectifying diode Dr1 and a second rectifying diode Dr2. The duty ratio and frequency modulating apparatus 51 generates an error signal (see FIG. 7, the error signal is a feedback signal) based on a sensed voltage generated by the voltage sensor 121 and a reference voltage via the comparator 122, and the error signal is inputted to a feedback terminal of the duty ratio and frequency modulator 511. The duty ratio and frequency modulator 511 generates a driving signal according to the error signal, and the driving signal is outputted from a gate drive terminal of the duty ratio and frequency modulator 511 and is sent to the respective control terminals of the first to the fourth power switches (Q1-Q4) for modulating the frequency of the DC/AC switching device 11 (respectively the waveforms of duty ratio and frequency are shown as two waveform diagrams at the connecting node of C_{B} and Lk in FIG. 7) so as to regulate a DC output voltage V0, which is the voltage in between the output capacitor C_{O} and a ground.

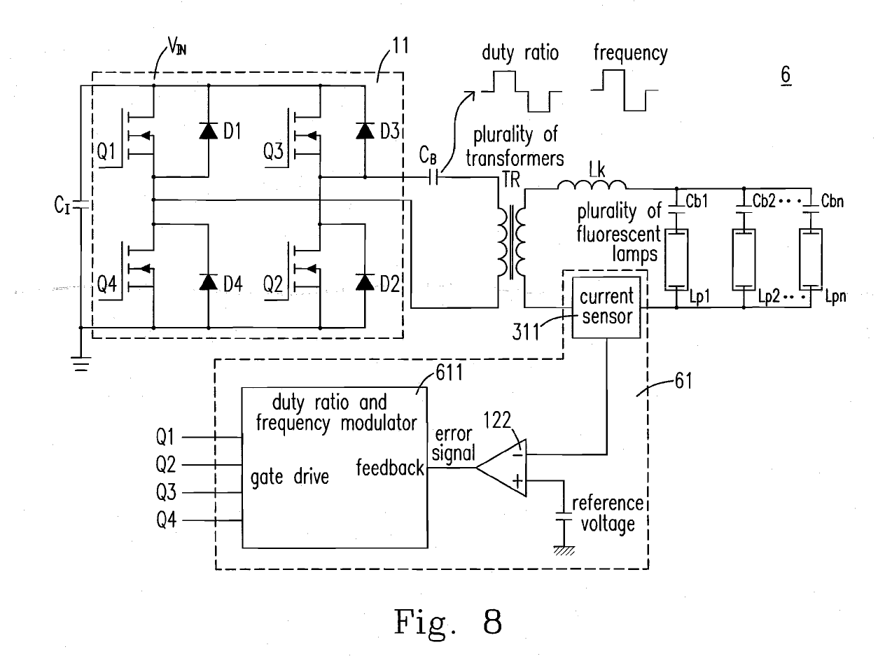

Please refer to FIG. 8, which shows a schematic circuit diagram of an isolated DC/AC converter having a duty ratio and frequency modulating apparatus according to the second preferred embodiment of the present invention. The isolated DC/AC converter having a duty ratio and frequency modulating apparatus 6 includes a DC/AC switching device 11, a duty ratio and frequency modulating apparatus 61, an input capacitor C_{I}, a block capacitor C_{B}, a plurality of transformers (each of which is represented by TR), a leakage inductor Lk, and a plurality of fluorescent lamps (Cb1+Lp1, Cb2+Lp2 . . . Cbn+Lpn), in which Cb1, Cb2 . . . Cbn are a plurality of ballast capacitors, and Lp1, Lp2 . . . Lpn are a plurality of fluorescent lamp tubes. The duty ratio and frequency modulating apparatus 61 includes a current sensor 311, a comparator 122 and a duty ratio and frequency modulator 611. The duty ratio and frequency modulating apparatus 61 generates an error signal based on a sensed current generated by the current sensor 311 and a reference voltage via the comparator 122 (see FIG. 8, the error signal is a feedback signal), and the error signal is inputted to the feedback terminal of the duty ratio and frequency modulator 611. The duty ratio and frequency modulator 611 generates a driving signal according to the error signal, and the driving signal is outputted from a gate drive terminal of the duty ratio and frequency modulator 611 and is sent to the respective control terminals of the first to the fourth power switches (Q1-Q4) for modulating a duty ratio and a frequency of the DC/AC switching device 11 (respectively the waveforms of duty ratio and frequency are shown as two waveform diagrams at the connecting node of C_{B} and the transformer TR in FIG. 8) so as to regulate the AC output voltage (not shown) across the two connecting nodes of the plurality of fluorescent lamps electrically connected in parallel (which are equivalent to a load).

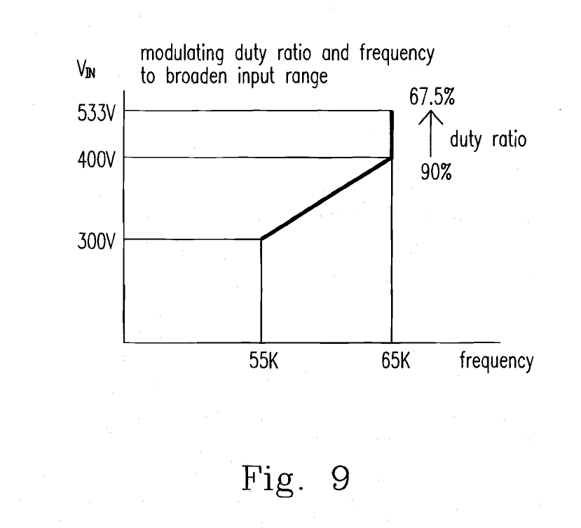

Please refer to FIG. 9, which shows a waveform diagram of input voltage (a DC input voltage V_{IN}) vs. frequency and duty ratio while the duty ratio and the frequency of the provided converter according to the first/the second preferred embodiments of the present invention are modulated to achieve a relatively broader input voltage range. Firstly, if the frequency is modulated and the duty ratio is 90%, the DC input voltage V_{IN} is modulated within the range of 300 V to 400 V while the corresponding frequency is modulated within the range of 55 K to 65 K. Secondly, when the DC input voltage V_{IN} reaches 400 V and the corresponding frequency reaches 65 K, the frequency is fixed at 65 K, and the modulation of duty ratio begins. When the duty ratio is modulated within a range, which decreases from 90% to 67.5%, the corresponding DC input voltage V_{IN} is modulated within the range of 400 V to 533 V. That is to say, the DC input voltage V_{IN} has a relatively broader input range.

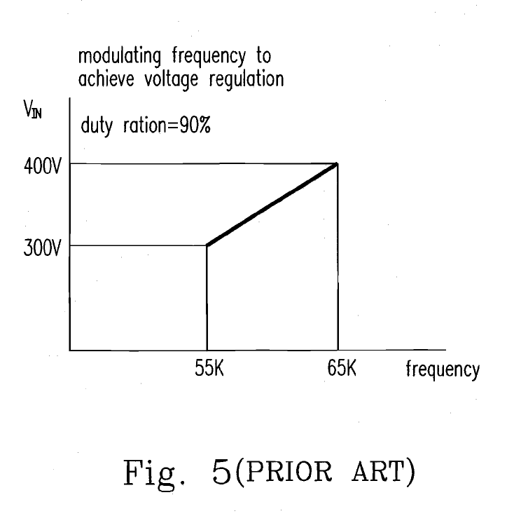

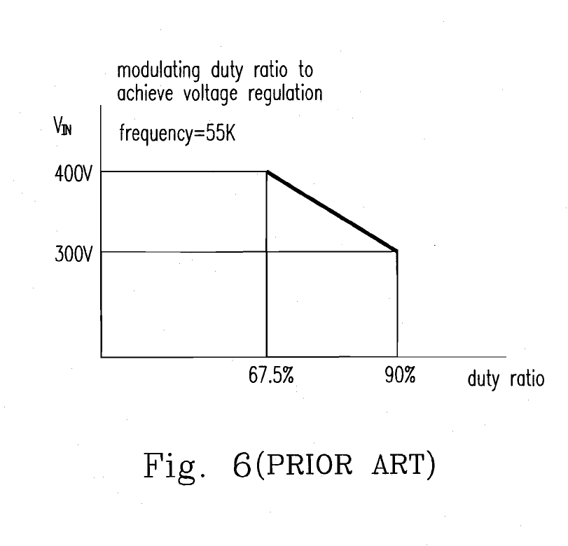

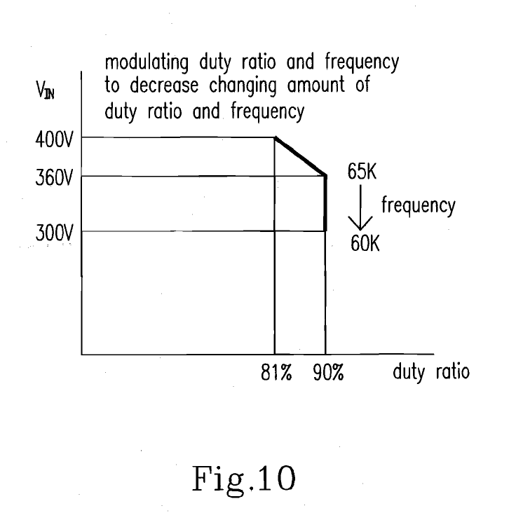

Please refer to FIG. 10, which shows a waveform diagram of input voltage (DC input voltage V_{IN}) vs. frequency and duty ratio while the duty ratio and the frequency of the provided converter according to the first/the second preferred embodiments of the present invention are modulated to achieve relatively lower changing amounts of duty ratio and frequency. Firstly, if the duty ratio is modulated and the frequency is fixed at 65 K, the DC input voltage V_{IN} is modulated within the range of 400 V to 360 V while the corresponding duty ratio is modulated within the range of 81% to 90%. Secondly, when the DC input voltage V_{IN} reaches 360 V and the duty ratio is fixed at 90%, the modulation of frequency begins. When the frequency is modulated within a range, which decreases from 65 K to 60 K, the corresponding DC input voltage V_{IN} is modulated within the range of 360 V to 300 V. Through the two stages of frequency modulation and duty ratio modulation, the DC input voltage V_{IN} of the converter is modulated within the range of 400 V to 300 V, the duty ratio is modulated within the range of 81% to 90%, and the frequency is modulated within the range of 65 K to 60 K. As compared with FIGS. 5 and 6 of the prior art, when the DC input voltage V_{IN} of the converter is modulated within the range of 400 V to 300 V, the frequency is modulated within the range of 55 K to 65 K according to FIG. 5, and the duty ratio is modulated within the range of 67.5% to 90% according to FIG. 6. Thus, the relative results generating via modulating the duty ratio and the frequency of the first/second preferred embodiments of the present invention do achieve relatively lower changing amounts of duty ratio and frequency.

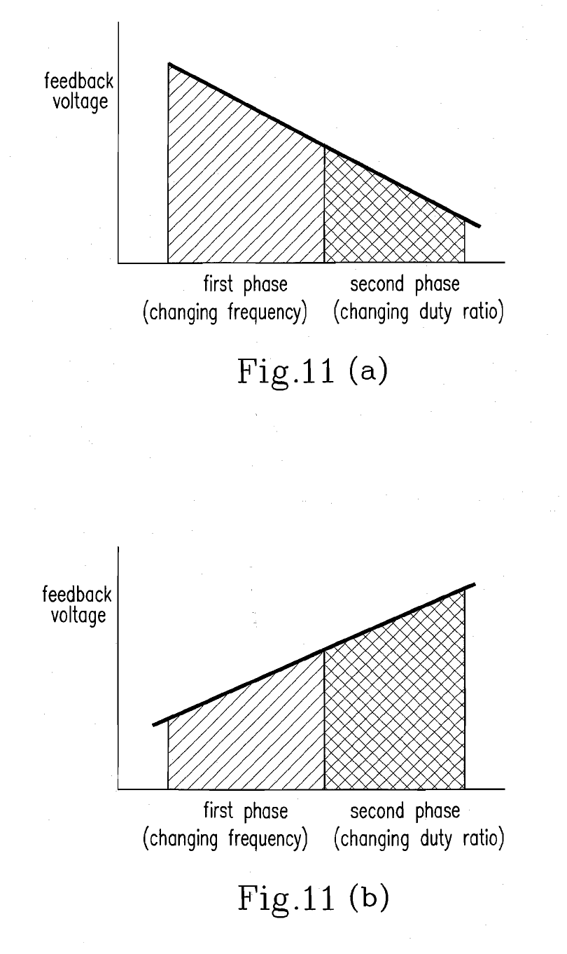

Please refer to FIG. 11(a), it shows a waveform diagram of feedback voltage vs. frequency/duty ratio, which indicates a decrease of the feedback voltage while changing the frequency within a first phase range when the duty ratio and frequency modulating apparatus 51/61 of the converter of the first/the second preferred embodiments of the present invention is working under a first operational mode, and a decrease of the feedback voltage while changing the duty ratio within a second phase range when the modulating apparatus is working under a second operational mode respectively. In which, the feedback voltage is a voltage value of the error signal (the feedback signal) receiving by the feedback terminal of the duty ratio and frequency modulating apparatus 51/61, and the feedback voltage is decreased gradually via changing the frequency during the first phase range and via changing the duty ratio during the second phase range.

Please refer to FIG. 11(b), it shows a waveform diagram of feedback voltage vs. frequency/duty ratio, which indicates an increase of the feedback voltage while changing the frequency within a first phase range when the duty ratio and frequency modulating apparatus 51/61 of the converter of the first/the second preferred embodiments of the present invention is working under a first operational mode, and an increase of the feedback voltage while changing the duty ratio within a second phase range when the modulating apparatus is working under a second operational mode respectively. In which, the feedback voltage is a voltage value of the error signal (the feedback signal) receiving by the feedback terminal of the duty ratio and frequency modulating apparatus 51/61, and the feedback voltage is increased gradually via changing the frequency during the first phase range and via changing the duty ratio during the second phase range. One with an ordinary skill in the field would know that the first phase range and the second phase range could be either overlapped or not overlapped.

According to the aforementioned descriptions, an isolated DC/DC converter having a relatively better effectiveness is provided to regulate a DC output voltage via adjusting a duty ratio and a frequency of the converter so as to achieve the advantages of having a relatively broader input voltage range and decreasing variation amounts of the duty ratio and the frequency. Besides, an isolated DC/AC converter having a relatively better effectiveness is also provided to regulate an AC output voltage via adjusting a duty ratio and a frequency of the converter so as to achieve the advantages of having a relatively broader input voltage range and decreasing variation amounts of the duty ratio and the frequency.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

1. An isolated DC/DC converter, comprising:
a DC/AC switching device receiving a DC input voltage for outputting a first AC output voltage;
a transformer receiving the first AC output voltage for outputting a second AC output voltage;
a rectifier receiving the second AC output voltage for outputting a DC output voltage; and
a duty ratio and frequency modulating apparatus coupled to the rectifier and the DC/AC switching device for generating a driving signal to adjust a duty ratio and a frequency of the DC/AC switching device so as to regulate the DC output voltage accordingly.

2. A converter according to claim 1, wherein the duty ratio and frequency modulating apparatus comprises:
a voltage sensor coupled to the rectifier for generating a sensed voltage;
a comparator receiving the sensed voltage and a reference voltage for generating a feedback signal; and
a duty ratio and frequency modulator receiving the feedback signal for generating the driving signal to modulate the duty ratio and the frequency accordingly.

3. A converter according to claim 2, wherein the feedback signal is a voltage signal.

4. A converter according to claim 2, wherein the duty ratio and frequency modulating apparatus is switched between one of a first operational mode and a second operational mode according to the feedback signal, wherein the first operational mode is used to control the frequency, the second operational mode is used to control the duty ratio, the feedback signal is used to modulate the frequency within a first phase range when the duty ratio and frequency modulating apparatus is working under the first operational mode, and the feedback signal is used to modulate the duty ratio within a second phase range when the duty ratio and frequency modulating apparatus is working under the second operational model.

5. A converter according to claim 1, wherein the DC/AC switching device has a first input terminal, a second input terminal, a first output terminal and a second output terminal, and further comprises:
a first power switch module, comprising:
a first power switch having a first terminal coupled to the first input terminal, a second terminal coupled to the second output terminal and a control terminal; and
a first diode having an anode coupled to the second terminal of the first power switch and a cathode coupled to the first terminal of the first power switch;
a second power switch module, comprising:
a second power switch having a first terminal coupled to the first output terminal, a second terminal coupled to the second input terminal and a control terminal; and
a second diode having an anode coupled to the second terminal of the second power switch and a cathode coupled to the first terminal of the second power switch;
a third power switch module, comprising:
a third power switch having a first terminal coupled to the first terminal of the first power switch, a second terminal coupled to the first output terminal and a control terminal; and
a third diode having an anode coupled to the second terminal of the third power switch and a cathode coupled to the first terminal of the third power switch; and
a fourth power switch module, comprising:
a fourth power switch having a first terminal coupled to the second terminal of the first power switch, a second terminal coupled to the second terminal of the second power switch and a control terminal; and
a fourth diode having an anode coupled to the second terminal of the fourth power switch and a cathode coupled to the first terminal of the fourth power switch,
wherein the respective control terminals of the first to the fourth power switches are coupled to the duty ratio and frequency modulating apparatus and receive the driving signal.

6. A converter according to claim 5, further comprising:
a block capacitor having a first terminal coupled to the first output terminal of the DC/AC switching device and a second terminal;
a leakage inductor having a first terminal and a second terminal coupled to the rectifier; and
an output capacitor having a first terminal coupled to the rectifier and a second terminal coupled to a ground,
wherein the transformer further comprises a primary winding coupled to the second terminal of the block capacitor and the second output terminal of the DC/AC switching device, and a secondary winding having a first terminal coupled to the first terminal of the leakage inductor, a second terminal coupled to the rectifier and a central tap coupled to the second terminal of the output capacitor.

7. A converter according to claim 5, further comprising:
a block capacitor having a first terminal coupled to the first output terminal of the DC/AC switching device and a second terminal;
a leakage inductor having a first terminal coupled to the second terminal of the block capacitor and a second terminal; and
an output capacitor having a first terminal coupled to the rectifier and a second terminal coupled to a ground,
wherein the transformer further comprises a primary winding coupled to the second terminal of the leakage inductor and the second output terminal of the DC/AC switching device, and a secondary winding having a first and a second terminals coupled to the rectifier and a central tap coupled to the second terminal of the output capacitor.

8. A converter according to claim 1, wherein the rectifier is a half-bridge rectifier.

9. An isolated DC/AC converter, comprising:
a DC/AC switching device receiving a DC input voltage for outputting an AC output voltage; and
a duty ratio and frequency modulating apparatus coupled to the DC/AC switching device for generating a driving signal to adjust a duty ratio and a frequency of the DC/AC switching device so as to regulate the AC output voltage accordingly.

10. A converter according to claim 9, further comprising a transformer having a secondary winding, wherein the duty ratio and frequency modulating apparatus comprises:
a current sensor coupled to the secondary winding for generating a sensed current;
a comparator receiving the sensed current and a reference voltage for generating a feedback signal; and
a duty ratio and frequency modulator receiving the feedback signal for generating the driving signal to modulate the duty ratio and the frequency accordingly.

11. A converter according to claim 10, wherein the feedback signal is a current signal.

12. An isolated DC/AC converter comprising:
a DC/AC switching device receiving a DC input voltage for outputting an AC output voltage; and
a duty ratio and frequency modulating apparatus coupled to the DC/AC switching device for generating a driving signal to adjust a duty ratio and a frequency of the DC/AC switching device so as to regulate the AC output voltage accordingly,
wherein the DC/AC switching device is the DC/AC switching device as claimed in claim 5.

13. A converter according to claim 12, further comprising:
a block capacitor having a first terminal coupled to the first output terminal of the DC/AC switching device and a second terminal;
a leakage inductor having a first terminal and a second terminal;
a load having a first terminal coupled to the second terminal of the leakage inductor and a second terminal coupled to the duty ratio and frequency modulating apparatus; and
a transformer having a primary winding coupled to the second terminal of the block capacitor and the second output terminal of the DC/AC switching device, and a secondary winding coupled to the first terminal of the leakage inductor and the duty ratio and frequency modulating apparatus.

14. A converter according to claim 12, further comprising:
a block capacitor having a first terminal coupled to the first output terminal of the DC/AC switching device and a second terminal;
a leakage inductor having a first terminal coupled to the second terminal of the block capacitor and a second terminal;
a load having a first terminal and a second terminal coupled to the duty ratio and frequency modulating apparatus; and
a transformer having a primary winding having a first terminal coupled to the second terminal of the leakage inductor and a second terminal coupled to the second output terminal of the DC/AC switching device, and a secondary winding having a first terminal coupled to the first terminal of the load and a second terminal coupled to the duty ratio and frequency modulating apparatus.

15. A controlling method for an isolated DC/DC converter, wherein the converter comprises a DC/AC switching device, a rectifier and a duty ratio and frequency modulating apparatus coupled to the rectifier and the DC/AC switching device, comprising the steps of:
(a) receiving a DC input voltage via the DC/AC switching device for outputting an AC output voltage;
(b) receiving the AC output voltage via the rectifier for outputting a DC output voltage; and
(c) generating a driving signal via the duty ratio and frequency modulating apparatus for adjusting a duty ratio and a frequency of the DC/AC switching device so as to regulate the DC output voltage accordingly.

16. A method according to claim 15, wherein the step (c) further comprises the steps of:
(c1) generating a feedback signal via the duty ratio and frequency modulating apparatus such that the duty ratio and frequency modulating apparatus is switched between a first operational mode and a second operational mode accordingly;
(c2) controlling the frequency through the first operational mode and controlling the duty ratio through the second operational mode; (c3) modulating the frequency within a first phase range based on the feedback signal so as to generate the driving signal when the duty ratio and frequency modulating apparatus is working under the first operational mode; and
(c4) modulating the duty ratio within a second phase range based on the feedback signal so as to generate the driving signal when the duty ratio and frequency modulating apparatus is working under the second operational mode.

17. A method according to claim 16, wherein the duty ratio and frequency modulating apparatus comprises a voltage sensor coupled to the rectifier for generating a sensed voltage, in order to output the feedback signal accordingly.

18. A controlling method for an isolated DC/AC converter, wherein the converter comprises a DC/AC switching device and a duty ratio and frequency modulating apparatus coupled to the DC/AC switching device, comprising the steps of:
(a) receiving a DC input voltage via the DC/AC switching device for outputting an AC output voltage; and
(b) generating a driving signal via the duty ratio and frequency modulating apparatus for adjusting a duty ratio and a frequency of the switching device so as to regulate the AC output voltage accordingly.

19. A method according to claim 18, wherein the step (b) further comprises the steps of:
(b1) generating a feedback signal via the duty ratio and frequency modulating apparatus such that the duty ratio and frequency modulating apparatus is switched between a first operational mode and a second operational mode accordingly;
(b2) controlling the frequency through the first operational mode and controlling the duty ratio through the second operational mode;
(b3) modulating the frequency within a first phase range based on the feedback signal so as to generate the driving signal when the duty ratio and frequency modulating apparatus is working under the first operational mode; and
(b4) modulating the duty ratio within a second phase range based on the feedback signal so as to generate the driving signal when the duty ratio and frequency modulating apparatus is working under the second operational mode.

20. A controlling method according to claim 19, wherein the isolated DC/AC converter further comprises a transformer having a secondary winding, and the duty ratio and frequency modulating apparatus comprises a current sensor coupled to the second winding for generating a sensed current, in order to output the feedback signal accordingly.
